(19) United States
(12) Patent Application Publication
(10) Pub. No.: US 2026/0194384 A1
(43) Pub. Date: Jul. 9, 2026

(54) SYSTEM AND METHOD FOR MEASURING CONTAINER FILL LEVEL

(71) Applicant: HF Scientific, Inc., Cape Coral, FL (US)

(72) Inventor: Dorian Cauceglia, Fort Myers, FL (US)

(21) Appl. No.: 19/012,448

(22) Filed: Jan. 7, 2025

(51) Int. Cl. G01F 23/292

(52) U.S. Cl. CPC G01F 23/2928

(57) ABSTRACT

A system for detecting container fill level includes a container sized and configured to receive a quantity of media, a container cover positioned on and covering the container, and at least one sensor coupled to an outer surface of the container cover and spaced away from the media, the at least one sensor configured to detect a first distance between the sensor and a surface on which the container rests and a second distance between the sensor and the presence of an amount of media within the container. A computing device operably coupled to the at least one sensor is configured to determine a height of the container based on the first distance, determine a height of the media based on the second distance, and calculate a fill level of the container based on a ratio of the height of the container and the height of the media.

### FIELD OF THE INVENTION

The present invention relates generally to water softener salt tanks. More particularly, the present invention relates to a system and method for monitoring and measuring the percentage full of a water softener salt tank relative to its height without opening it.

### BACKGROUND OF THE INVENTION

Salt-based water softeners are used to turn hard water into soft water. The goal is to reduce scale buildup to extend the lifespan of appliances and plumbing systems, which in turn lowers maintenance and repair costs. Other benefits include less staining on fixtures, sinks, toilets, and glassware, and better lathering soaps and detergents. Salt-based water softener systems are used in both residential and commercial/industrial settings.

A water softener system typically consists of three main components. The first component is a resin tank (softening tank) that contains a bed of resin covered with sodium or potassium ions to soften the water. The second component is a brine tank that stores salt and is used to mix a highly concentrated saltwater solution called “brine” that is required for regeneration of the resin tank by flushing the resin with the brine. The third component is a valve system connected to the resin tank that operates the system, putting it through its various cycles and controlling water flow direction and rate.

When hard water enters the softening tank, it passes through the resin bed. The calcium (Ca²⁺) and magnesium (Mg²⁺) ions in the water are attracted to and bond with the negatively charged resin. In exchange, the resin releases sodium (Na⁺) ions into the water. This ion exchange process effectively removes hardness from the water. Over time, the resin becomes saturated with calcium and magnesium ions and can no longer soften water effectively. At this point, the system triggers the regeneration cycle. The control valve directs a concentrated brine solution (from the brine tank) to flow through the resin bed. The sodium ions in the salt solution replace the hardness ions (Ca²⁺ and Mg²⁺), which are flushed out of the system. The resin particles are recharged and ready to soften water again. After the regeneration cycle, the system flushes out excess salt and replenishes the brine tank with fresh water, dissolving salt to prepare for the next regeneration cycle.

During operation of the water softener system, the salt in the brine tank is used up over time and needs to be replenished in order to maintain the effectiveness of the water softener system. When the brine tank runs out of salt, it causes hard water to pass through the system causing the water to have undesirable characteristics. As salt consumption may vary with water usage, it may be difficult for a home or business owner to predict when the brine tank should be refilled without the inconvenience of regularly performing a visual inspection of the brine tank to assess the level of media in the tank, e.g., salt level. Further, visually estimating the salt level in the tank is often inaccurate.

To address this problem, a number of different salt tank monitoring systems have been developed. For example, U.S. Pat. No. 11,657,695 describes the use of a monitoring mechanism that includes a sensor positioned partially outside of the tank and partially inside the tank. The mechanism utilizes a direct detection device that needs to be positioned inside the tank through an opening in the cover to detect the upper level of salt in the tank. In alternative embodiments, an indirect detection device may be positioned on an outside wall of the tank and measure the presence of salt adjacent the device based on capacitance values. Once the upper level of salt within the tank has reaches a predetermined lower limit, the system sends out warning signal indicating that the salt should be replenished. Similarly, U.S. Pat. No. 10,872,515 describes a monitoring system that utilizes sensors affixed to a tank wall that measure the presence of salt adjacent the sensor based on capacitance values.

U.S. Pat. No. 11,724,945 describes the use of a salt monitoring mechanism that uses a distance sensor positioned on the inside of the brine tank, e.g., attached to the interior surface of a tank cover. The monitoring mechanism requires the tank cover to be removed in order to install the mechanism inside the brine tank.

US2019/0170560, US 2022/0113178, US 2022/0136886, US 2006/0114593, US 2018/0052033, and U.S. Pat. No. 9,791,308 describe monitoring systems that utilize a sensor (typically, an infrared sensor) capable of measuring the distance between the sensor and the salt solution within the brine tank. When the measured distance reaches a predetermined threshold associated with a low-media condition within the brine tank, the system generates an alarm signal and may initiate a refilling protocol. The sensors are positioned on the inside of the brine tank or through an opening in the cover of the brine tank.

The above discussed existing salt-level monitoring systems suffer from a number of drawbacks. The typically have designs with many components that make the system too expensive to manufacture and too difficult to install, especially if the monitoring system needs to be retrofitted onto existing salt water softening systems. Many known systems rely on complicated capacitance-based detection or mechanical systems that require a direct contact between the sensor and the brine solution, which makes such systems prone to degradation or corrosion from prolonged immersion in the salt. Additionally, these systems utilize sensors that require to be positioned on an inside of the tank, which requires a user to open the tank and makes it more difficult to retrofit the monitoring system to the existing brine tank. Further, the known systems typically measure the distance between the sensor and the salt level within the tank and are only capable of alerting the user when the last level reaches a predetermined low threshold, which makes it difficult to prepare for the low salt level event in advance. Additionally, the prior art systems typically measure the internal height of the tank fill without regard to the size of the tank or require that the tank size be manually entered.

Because of the above-listed issues, a need for brine tank monitoring systems that do not require the tank cover to be removed in order to install and use the monitoring system. There is also a need for monitoring systems that do not require components to be positioned inside the tank and that avoid direct interaction between the sensing components and the media within the tank. There is further a need for brine tank monitoring systems that can measure a fill level of salt in brine tanks of various sizes to provide an advance notice of low salt level event. There is also a need for monitoring systems that can be easily adapted to different shapes and sizes of brine tanks, and that do not interfere with the system operation and can be easily moved/repositioned to allow refilling of the brine tank. There is further a need for monitoring systems that can accurately calculate height of internal content based on correct height of the container.

### SUMMARY OF THE INVENTION

In order to overcome the deficiencies of the prior art and to achieve at least some of the objectives and advantages listed, the invention comprises a system for detecting container fill level, which includes a container sized and configured to receive a quantity of media, a container cover positioned on and covering the container, and at least one sensor coupled to an outer surface of the container cover and spaced away from the media, the at least one sensor configured to detect a first distance between the sensor and a surface on which the container rests and a second distance between the sensor and the presence of an amount of media within the container. A computing device is operably coupled to the at least one sensor and is configured to determine a height of the container based on the first distance, determine a height of the media based on the second distance, and calculate a fill level of the container based on a ratio of the height of the container and the height of the media. The system is configured to detect any type of media, including a solid, a liquid and a mixture thereof.

In some embodiments, the at least one sensor includes a first sensor and a second sensor, wherein the first sensor is positionable adjacent a perimeter of the container such that a signal emitted from the first sensor does not interact with any portion of the container, and the second sensor is positionable adjacent the container cover such that a signal emitted from the second sensor travels through the container cover. In some of these embodiments, the first sensor is an infrared sensor and the second sensor is a millimeter-wave sensor.

In certain embodiments, the system further includes an extension arm having a first end coupled to the at least one sensor and a second end coupled to the container cover. In some of these embodiments, the extension arm is extendable and collapsible to position the at least one sensor to detect the first distance and the second distance.

In some cases, the at least one sensor includes at least one emitter configured to emit a signal, at least one receiver configured to receive a reflected signal, at least one processor in communication with the at least one emitter and the at least one receiver, and a memory device configured as a non-transitory computed readable medium in communication with the at least one processor. The processor is configured to execute instructions stored by the memory that cause the system to measure the first distance and the second distance and to calculate the fill level of the container. In some of these embodiments, the processor is configured to compare the calculated fill level of the container to a predetermined threshold fill value stored by the memory device and to generate a low salt condition indication.

According to another example embodiment of the present technology, a system for detecting container fill level includes a container sized and configured to receive a quantity of media, a container cover positioned on and covering the container, and at least one sensor coupled to an outer surface of the container cover and spaced away from the media. The at least one sensor is positionable in a first position adjacent a perimeter of the container such that a signal emitted from the first sensor does not interact with any portion of the container and is configured to detect a first distance between the sensor and a ground surface on which the container rests, and is positionable in a second position adjacent the container cover such that a signal emitted from the second sensor travels through the container cover and is configured to detect a second distance between the sensor and the presence of an amount of media within the container. A computing device is operably coupled to the at least one sensor and is configured to determine a height of the container based on the first distance, determine a height of the media based on the second distance, and calculate a fill level of the container based on a ratio of the height of the container and the height of the media.

According to yet another exemplary embodiment of the present technology, a method for detecting container media fill level is provided including the steps of providing at least one sensor comprising an emitter and a receiver, positioning the at least one sensor in a first position and measuring a height of the container, positioning the at least one sensor in a second position and measuring a height of media in the container, and providing a controller in communication with the at least one sensor, the controller calculating a fill level of the container based on a ratio of the height of the container and the height of the media.

In some embodiments, the step of measuring the height of the container includes emitting an outgoing signal from the at least one sensor towards a ground surface on which the container rests, receiving an incoming reflected signal, and calculating a first distance between the at least one sensor and the ground surface, wherein the outgoing signal and the incoming reflected signal do not interact with any portion of the container.

In certain embodiments, the step of measuring the height of media in the container includes emitting an outgoing signal from the at least one sensor towards the media in the container, receiving an incoming reflected signal, and calculating a second distance between the sensor and the presence of an amount of media within the container, wherein the outgoing signal and the incoming reflected signal travel through a container cover.

In some cases, the method further includes the step of transmitting the calculated fill level of the container to a user device via a wireless network.

In some embodiments, the method also includes the steps of inputting a predetermined threshold fill value, comparing the calculated fill level of the container to the predetermined threshold fill value, generate a low salt condition indication if the calculated fill level of the container exceeds the predetermined threshold fill value.

In certain embodiments, the at least one sensor includes a first sensor and a second sensor, and the method also includes the steps of measuring the height of the container with the first sensor and measuring the height of media in the container with the second sensor.

In certain embodiments, the method includes the steps of storing the measured height of the container value, repeatedly measuring the height of media in the container, repeatedly calculating the fill level of the container based on a ratio of the stored height of the container value and the measured height of the media value.

In some embodiments, the step of positioning the at least one sensor in the first position includes coupling the at least one sensor to an extension arm and extending the extension arm such that the at least one sensor is positioned adjacent a perimeter of the container. In certain of these embodiments, the step of positioning the at least one sensor in the second position includes collapsing the extension arm such that the at least one sensor is positioned over a container cover.

In some embodiments, the steps of measuring the height of media in the container and calculating the fill level of the container are performed in predetermined time intervals.

In additional embodiments, the steps of measuring the height of media in the container and calculating the fill level of the container are performed continuously.

Other objects of the invention and its particular features and advantages will become more apparent from consideration of the following detailed description.

### BRIEF DESCRIPTION OF THE DRAWINGS

The features of the application can be better understood with reference to the drawings described below, and the claims. The drawings are not necessarily to scale, emphasis instead generally being placed upon illustrating the principles described herein. In the drawings, like numerals are used to indicate like parts throughout the various views.

FIG. 1 is a schematic view of a prior art water softener system.

FIG. 2 is a schematic view of a system for detecting container fill level in accordance with an embodiment of the present invention, showing a single sensor in an extended configuration.

FIG. 3 is a schematic view of the system for detecting container fill level of FIG. 2, showing the single sensor in a collapsed configuration.

FIG. 4 is a schematic view of the system for detecting container fill level of FIG. 2, showing an exemplary embodiment with a first sensor and a second sensor.

FIG. 5 is an embodiment of a method for determining a level of media in a tank in accordance with the present invention.

FIG. 6 is a block diagram of an environment for an embodiment of a system for detecting container fill level in accordance with the present invention.

### DETAILED DESCRIPTION OF THE INVENTION

The following definitions and methods are provided to better define the present disclosure and to guide those of ordinary skill in the art in the practice of the present disclosure. Unless otherwise noted, terms are to be understood according to conventional usage by those of ordinary skill in the relevant art.

As used in the description, the terms “top,” “bottom,” “above,” “below,” “over,” “under,” “above,” “beneath,” “on top,” “underneath,” “up,” “down,” “upper,” “lower,” “front,” “rear,” “back,” “forward” and “backward” refer to the objects referenced when in the orientation illustrated in the drawings, which orientation is not necessary for achieving the objects of the invention.

The term “about” or “approximately” when immediately preceding a numerical value means a range (e.g., plus or minus 10% of that value). For example, “about 50” can mean 45 to 55, “about 25,000” can mean 22,500 to 27,500, etc., unless the context of the disclosure indicates otherwise, or is inconsistent with such an interpretation. For example, in a list of numerical values such as “about 49, about 50, about 55, . . . ”, “about 50” means a range extending to less than half the interval(s) between the preceding and subsequent values, e.g., more than 49.5 to less than 52.5. Furthermore, the phrases “less than about” a value or “greater than about” a value should be understood in view of the definition of the term “about” provided herein. Similarly, the term “about” when preceding a series of numerical values or a range of values (e.g., “about 10, 20, 30” or “about 10-30”) refers, respectively to all values in the series, or the endpoints of the range.

As used herein, the singular forms “a,” “an,” and “the” include plural referents unless the content clearly dictates otherwise.

The term “comprising” is synonymous with “including,” “having,” “containing,” or “characterized by.” These terms are inclusive and open-ended and do not exclude additional, unrecited elements or method steps.

Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The following description is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown but are to be accorded the widest scope consistent with the principles and features disclosed herein. The following detailed description is to be read with reference to the figures, in which like elements in different figures have like reference numerals. Skilled artisans will recognize the examples provided herein have many useful alternatives and fall within the scope of embodiments of the invention.

Additionally, while the following discussion may describe features associated with specific devices, it is understood that additional devices and or features can be used with the described systems and methods, and that the discussed devices and features are used to provide examples of possible embodiments, without being limited.

The present technology provides a system for detecting container fill level configured to measure and report a percentage fill of a brine tank relative to its height without the need to open the tank.

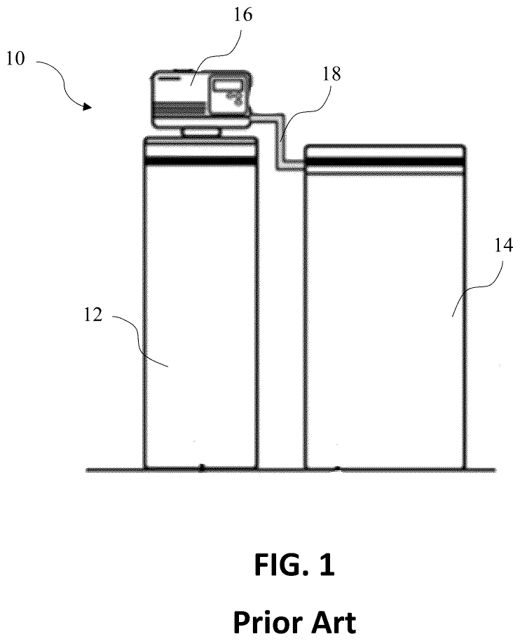

A typical water softener system is illustrated in FIG. 1. The water softener system 10 includes three main components. A resin tank 12 contains a bed of resin, covered with sodium or potassium ions to soften the water. A brine tank 14 stores salt and is used to mix a highly concentrated saltwater solution—“brine”—that is required for regeneration of the resin tank. A control valve 16 sits on top of the resin tank 12 and operates the system 10, putting it through its various cycles and controlling water flow direction and rate. The control valve 16 is fluidly connected to the brine tank 14 through piping 18. The control valve 16 typically includes a structure for directing the flow of fluid to complete the regeneration process, such as a reciprocating piston, rotating disc or poppets. The regeneration process controlled by the control valve 16 may include a number of steps, such as a backwash cycle to remove turbidity from the resin bed, a brine draw cycle to introduce the brine solution to the resin bed, a rinse to eliminate chlorides in the finished water, and a brine refill cycle to prepare a brine solution for the next regeneration. Such water softener systems are well known in the art and are described in detail for example in U.S. Pat. Nos. 6,644,349; 6,696,966; 7,566,738; and 8,302,631, all of which are incorporated by reference.

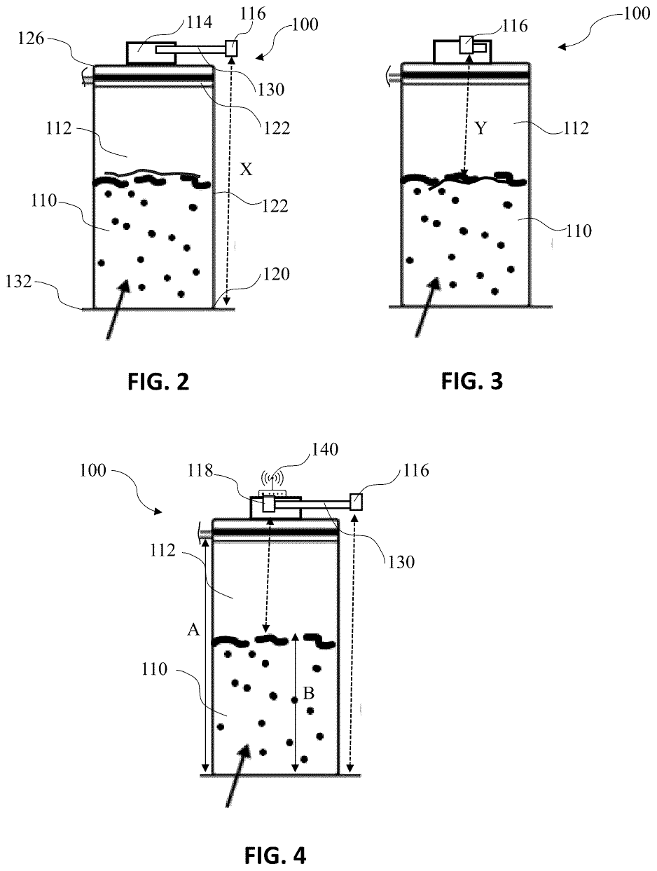

FIGS. 2-3 show a brine tank 112 with the system for detecting container fill level 100 in accordance with an exemplary embodiment of the present technology. The brine tank 112 may be generally rectangular in shape and include a body with a closed lower end 120, a generally cylindrical sidewall 122 extending upwardly from the lower end and an open upper end 124 opposite the lower end 120. The brine tank 112 also includes a cover 126 that may releasably engage the upper end 124 to enclose the tank body. In some cases, the brine tank 112 may include a brine well (not shown) attached to the inside or outside of the brine tank 112, from which brine generated in the brine tank 112 is periodically drawn into the resin tank during the regeneration phase of the softener operational cycle. The brine tanks described are readily available through various commercial vendors. The brine tank 112 is filled with a concentrated saltwater solution—“brine” 110.

The tank 112 also includes the system for detecting container fill level 100 mounted to the tank 112. In some preferred embodiments, the detection system 100 is removably mounted to the cover 126 such that it may be easily and quickly installed on any tank. The system 100 includes one or more sensors. The sensors may be distance detection type sensors, such as an ultrasonic distance detector, a laser distance detector, an infrared distance detector, an electromagnetic wave distance detector, a microwave distance detector, or any other type of detector that works by emitting a signal and receiving that signal after it interacts with a media and bounces back. The sensors measure the time between emission of the signal and receipt of the bounce-back signal. Various components of the detection system may be housed in a housing 114 coupled to or placed on the cover 126.

The system for detecting container fill level in accordance with the present technology is configured to measure any media content of a tank, including solids, liquids, and mixtures thereof. In some embodiments, the system is configured to measure content of saltwater solution—i.e., brine—in the brine tank. Although the present technology is described in the content of saltwater water softening systems, and in particular, a brine tank, it is understood that the present system and method is suitable for measuring any content of liquid, solids or mixtures thereof in any type of container.

FIG. 2 illustrates the system for detecting container fill level 100 with a single sensor 116 coupled to the tank cover 126. The sensor 116 is configured to measure a distance between the sensor and the ground or any other surface 132 on which the lower end 120 of the brine tank 112 is positioned. This distance is labeled as distance “X” in FIG. 2. The sensor 116 includes a signal emitter, a signal receiver, and a processor. The sensor 116 may be oriented such that the emitted signal is directed toward the ground surface 132. The sensor 116 is configured to emit a signal via the signal emitter, receive a bounce-back response signal via the signal receiver, and to provide to the processor notifications of such events, or the elapsed time between such events, to be used for determining a distance from the sensor 116 to the ground surface 132 or any surface on which the tank rests.

In some preferred embodiments, the sensor 116 is coupled to the brine tank 112 via an extension arm 130. The extension arm 130 has a first end coupled to the cover 126 of the brine tank 112 and a second end that supports the sensor 116, as illustrated in FIG. 2. The extension arm 130 is configured such that the second end extends beyond the outer edge of the brine tank 112. This allows the sensor 116 to be positioned such that the signal emitted from the sensor travels towards the ground surface 132 without interacting with or passing through the cover, sidewall or any other part of the tank 112. In some embodiments, the extension arm is adjustable in length to accommodate various sizes of brine tanks. For example, the extension arm 130 may have a telescoping structure allowing the arm to be extended further for larger diameter tanks and to be shortened for smaller diameter tanks, which allows the detection system 100 to be easily retrofitted onto various types of existing brine tanks. In additional embodiments, the extension arm 130 may be provided with an adjustable orientation mechanism that allows the arm to be moved out of the way when it is necessary to gain access to the brine tank 112 or to better position the sensor 116 towards the ground surface 132 for optimal distance measurement. Any suitable adjustable mechanism, such as ball-and-socket joint, swivel ball joint or ball socket, may be used to couple the extension arm 130.

In some embodiments, the sensor 116 is an infra-red sensor, such as infrared time-of-flight (ToF) sensor. ToF sensor uses infrared light to measure the distance between an object and a sensor by measuring the time it takes for the light to bounce off the object and return to the sensor. The signal emitter emits infrared light, which bounces off the ground surface 132 and is received by the signal receiver. A timer measures the amount of time for the emitted wave to return to the sensor. Based on this “time of flight” of the wave and a known speed of the wave (e.g., the speed of light in this case), the processor calculates the distance “X” from the sensor 116 to the ground surface 132 by using the following formula:

$$Distance = \frac{Speed of Light \times Time of Flight}{2} \qquad Formula I$$

This calculated distance “X” is used as a tank height value “A”. By providing the sensor component configured to measure the height of the brine tank 112, the tank capacity may be easily and accurately measured by the monitoring system, thus making the system particularly suitable for being retrofitted on various tank sizes without the need to separately input the tank size measurements.

As shown in FIG. 3, the sensor 116 may be repositioned and placed at the top end 124 of the brine tank 112. This may be achieved by collapsing the extension arm 130 or by any other suitable mechanism. The sensor 116 is then configured to measure a distance between the sensor and the media inside the brine tank, such as brine solution 110. This distance is labeled as distance “Y” in FIG. 3. In this configuration, the sensor 116 is preferably oriented to face downwardly such that the emitted signal is directed toward the bottom 120 of the tank 112. The sensor 116 is configured to emit a signal via the signal emitter, which bounces off a top surface of the brine solution 110 contained in the brine tank 112. The bounce-back response signal is then received via the signal receiver. A timer measures the amount of time for the emitted wave/signal to return to the sensor and provides this information to the processor, which determines the distance “Y” from the sensor 116 to the top surface of the liquid in the tank 112.

In some embodiments of the present technology, the sensor 116 may include a millimeter-wave (mmWave) type sensor component. mmWave sensors use short-wavelength electromagnetic waves to detect objects and measure their movement, velocity, and angle. mmWave sensor transmits electromagnetic waves via a transmitter, such as antenna array, and detects the reflections from objects in its path via a receiver, such as antenna array. The time it takes for the signal to reflect, and the phase difference of the reflected signal are used to calculate the distance and speed of the object. mmWave sensor typically uses 1 to 300 gigahertz (GHz). mmWave sensor may use the 2 GHz, 24 GHz, 60 GHz, and 77-81 GHz bands, as suitable. Each band has its own benefits for specific applications. Because the mmWave sensor uses electromagnetic waves, the sensor does not need to be placed inside the brine tank and can be positioned on the outside of the tank without the need to open the tank cover. The electromagnetic waves travel through the tank cover 126 and will be reflected back from the liquid contents of the tank. A timer measures the amount of time for the emitted wave to return to the sensor. The processor then calculates the distance “Y” from the sensor 116 to the top surface of the brine solution 110 based on the time of flight of the wave and a known speed of the wave (e.g., the speed of light in this case) by using Formula I above. This calculated distance “Y” is used as a level of fluid (fill level) in the tank value “B”.

It is understood that in various embodiments of the present technology, the sensor 116 may be any suitable distance sensor, such as ultrasonic distance sensor, electromagnetic wave distance sensor, microwave distance sensor or laser-based distance sensor, or any other types of sensors described above. In some embodiments, a light detection and ranging (LiDAR) ToF sensor may be used. LiDAR systems employ more powerful laser light sources that can extend their operational range and provide detailed, high-resolution spatial data.

In some embodiments, the sensor 116 may be positioned such that the sensor is directly exposed to the inside of the brine tank 112 such that the signal emitted by the sensor emitter does not travel through any portion of the tank before it reaches the top surface of the liquid contained in the tank. For example, the tank cover 126 may be provided with an opening and the sensor may be installed and secured in such opening.

In some embodiments, such as shown in FIG. 4, a first sensor 116 and a second sensor 118 may be provided. The first sensor 116 is affixed to an extendable arm 130 and is positioned such that the signal emitted from the sensor travels towards the ground surface 132 without interacting with or passing through the cover, sidewall or any other part of the tank 11 to measure the distance “X”. The second sensor 118 is positioned at the top end 124 of the brine tank 112 and configured to measure a distance between the sensor and the media inside the brine tank through the tank cover 126. The first sensor 116 may be an infrared time-of-flight (ToF) sensor and the second sensor 118 may be a millimeter-wave (mmWave) type sensor, as described above. This design eliminates the need to adjust the positioning of the sensor to measure the tank height “A” and the tank fill level “B”. In this embodiment, the sensors 116 and 118 may take measurements simultaneously and/or continuously to provide for a more accurate monitoring system that requires minimum user interaction.

The sampling frequency or schedule for the sensors may be configured as desired. For example, the sensor may have a continuous, timed mode where the sensor is continuously active and emits waves periodically with a standard time interval, e.g., every 3 seconds, between each emission of wave and measurement of time of flight until the reflected wave is detected. In another exemplary embodiment, the sensor may include a continuous mode where the sensor continuously emits waves to measure the level of media 110 within the tank 112 in real-time. In a further exemplary embodiment, the sensor may include a single mode where the sensor emits a wave only once at a predetermined time or when prompted by the user. After emitting a wave and measuring the distances “X” and/or “Y”, the sensor may return to a stand-by mode awaiting instruction from the user to emit a subsequent wave. It is contemplated that further suitable modes having various time intervals and wave emission patterns may be applied to the sensor.

The system for detecting container fill level 100 also includes a power supply to provide power to the system components. For example, the power supply may be a battery source and/or the system may be configured to be powered via the water softening system. The detection system 100 also includes a computing device that preferably has a processing device and a memory device. The computing device may be a preprogrammed microprocessor or a system on chip. The computing device controls the signal emissions and signal detections discussed above. The computing device may utilize any suitable type of processing device, such as a central processing unit (CPU), and any suitable type of memory device, such as read only memory (ROM) and random access memory (RAM). In some embodiments, the computing device also includes user input devices to enable a user to provide inputs to the computing device, including, but not limited to, a touch-sensitive display device, such as a liquid crystal display (LCD), and smart devices, such as smart phones, tablet computers, etc., that can access applications. The detection system 100 further includes a wireless module 140, as shown in FIG. 4. The wireless module may include an antenna that connects to a network and enables communication to and/or from the network.

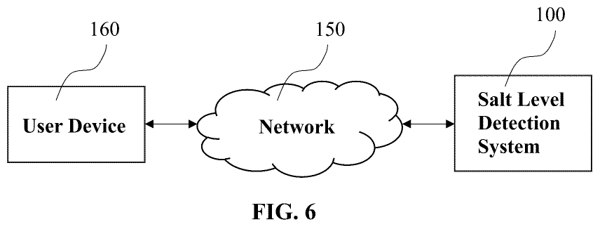

In some exemplary embodiments of the present technology, the detection system 100 is in communication with a network 150, as shown in FIG. 6. Exemplary networks may include Wi-Fi, Bluetooth, Bluetooth Low Energy (BLE), Zigbee, Near Field Communication, 6LoWPAN, cellular (e.g., CDMA, GSM, LTE), or other radio frequency communication systems. The network 150 may be a combination of more than one type of wireless networks and include the Internet and a Local Area Network. The system 100 is configured to send data, such as measured tank height, measured tank fill level and/or calculated tank percentage empty, to the network 150, which then sends the data to a user device 160. The user device 160 may be a smart phone, tablet computer, smart watch, or other internet-capable computing device.

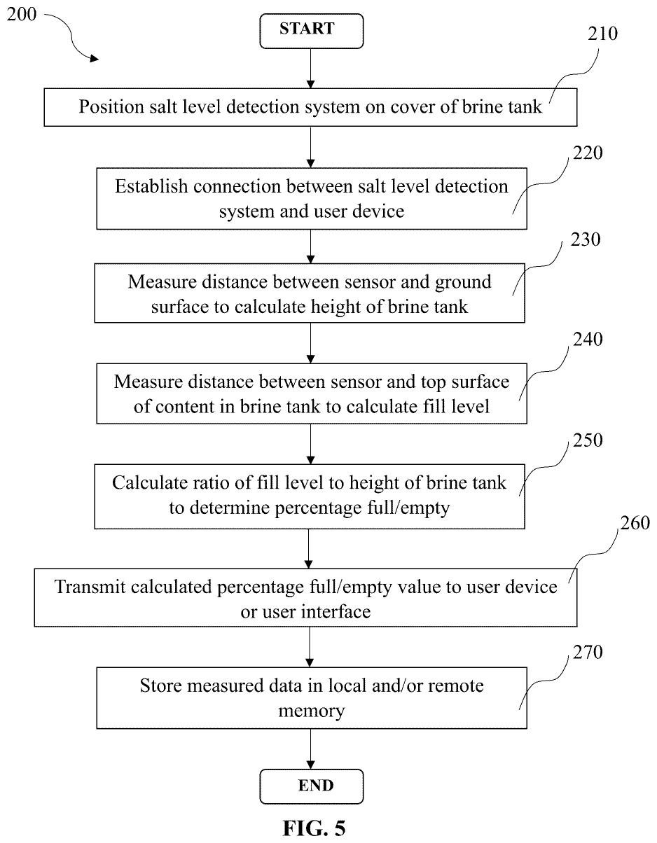

FIG. 5 illustrates an exemplary method 200 in accordance with the present technology. First, the detection system is positioned on the cover of the brine tank (operation 210). Next, a connection between the detection system and the user device is established over the network (operation 220). It is understood that the detection system of the present technology does not necessarily require connection to a user device and may include a user interface within the system, such as a display and/or user input device positioned adjacent the brine tank. The sensor is positioned over the ground surface, as shown in FIGS. 2 and 3, and is activated to emit a signal and receive the signal once it is reflected off the ground surface. The sensor measures the time required to receive the emitted signal. The measured data is processed by the processing unit to calculate a distance between the sensor and the ground surface based on Formula I to determine the height of the brine tank (operation 230). In the single sensor embodiment shown in FIGS. 2-3, the sensor is then positioned over the tank cover, as seen in FIG. 3. In the double sensor embodiment of FIG. 4, the second sensor is already placed over the tank cover. The sensor is activated to emit a signal and receive the signal reflected off the top surface of content in the brine tank, i.e., brine solution. The sensor measures the time required to receive the emitted signal and the measured data is processed by the processing unit to calculate a distance between the sensor and the tank content based on Formula I to determine the height of content in the tank (operation 240). The processing unit then calculates a ratio of the calculated height of content in the tank and the calculated tank height to determine a percentage of tank volume that is empty or filled (operation 250) based on the following formula:

$$Percentage Full / Empty = ( \frac{Height of Content}{Height of Tank} ) \times 100 \qquad Formula II$$

The calculated percentage full/empty value is then displayed on the user interface and/or transmitted to the user device over the network (operation 260). The measured data is also stored on the local and/or remote memory (operation 270).

In the one sensor embodiment of FIGS. 2-3, the height of the tank is measured once at the beginning of the process and the measured data is stored in the memory device. The sensor then takes continuous or intermittent measurements of the height of content in the tank and uses the stored tank height data to calculate the percentage full/empty value. In the two-sensor embodiment of FIG. 4, the first and second sensors can make continuous and/or intermittent measurements of the height of content and the tank height respectively to calculate the percentage full/empty value.

In some exemplary embodiments, the method may further include generating a warning signal to the user when the percentage fill/empty value reaches a certain predetermined threshold. For example, the computing device may be configured to compare a calculated percentage fill/empty value to a threshold value, such as about 25% empty, about 20% empty, about 15% empty, about 10% empty, about 5% empty, about 2% empty, about 1% empty or any other threshold value. If the calculated percentage empty reaches the threshold percentage empty, the system signals a low salt condition and proceeds to alert the user. The system may be configured to generate an audible and/or visual indication of the low salt condition to the user, such as an audible sound, a flashing light, a message to the user device, or any other suitable indication apparent to those of skill in the art. The low salt condition indication may be continuously generated by the system until a content level in the tank is increased and/or until the user turns off the indication signal.

It should be understood that the foregoing is illustrative and not limiting, and that obvious modifications may be made by those skilled in the art without departing from the spirit of the invention. Accordingly, reference should be made primarily to the accompanying claims, rather than the foregoing specification, to determine the scope of the invention.

What is claimed is:

1. A system for detecting container fill level, comprising:
a container sized and configured to receive a quantity of media;
a container cover positioned on and covering the container;
at least one sensor positioned on an outer surface of the container cover and spaced away from the media, the at least one sensor configured to detect a first distance between the sensor and a surface on which the container rests and a second distance between the sensor and the presence of an amount of media within the container,
a computing device operably coupled to the at least one sensor and configured to:
determine a height of the container based on the first distance,
determine a height of the media based on the second distance, and
calculate a fill level of the container based on a ratio of the height of the container and the height of the media.

2. The system according to claim 1, wherein the at least one sensor comprises a first sensor and a second sensor, wherein:
the first sensor is positionable adjacent a perimeter of the container such that a signal emitted from the first sensor does not interact with any portion of the container, and
the second sensor is positionable adjacent the container cover such that a signal emitted from the second sensor travels through the container cover.

3. The system according to claim 2, wherein the first sensor is an infrared sensor.

4. The system according to claim 2, wherein the second sensor is a millimeter-wave sensor.

5. The system according to claim 1, further comprising an extension arm having a first end coupled to the at least one sensor and a second end coupled to the container cover.

6. The system according to claim 5, wherein the extension arm is extendable and collapsible to position the at least one sensor to detect the first distance and the second distance.

7. The system according to claim 1, wherein the at least one sensor comprises:
at least one emitter configured to emit a signal,
at least one receiver configured to receive a reflected signal,
at least one processor in communication with the at least one emitter and the at least one receiver, and
a memory device configured as a non-transitory computed readable medium in communication with the at least one processor,
wherein the processor is configured to execute instructions stored by the memory that cause the system to measure the first distance and the second distance and to calculate the fill level of the container.

8. The system according to claim 7, wherein the processor is configured to compare the calculated fill level of the container to a predetermined threshold fill value stored by the memory device and to generate a low salt condition indication.

9. A system for detecting container fill level, comprising:
a container sized and configured to receive a quantity of media;
a container cover positioned on and covering the container;
at least one sensor positioned on an outer surface of the container cover and spaced away from the media, wherein the at least one sensor:
is positionable in a first position adjacent a perimeter of the container such that a signal emitted from the first sensor does not interact with any portion of the container and is configured to detect a first distance between the sensor and a surface on which the container rests, and
is positionable in a second position adjacent the container cover such that a signal emitted from the second sensor travels through the container cover and is configured to detect a second distance between the sensor and the presence of amount of media within the container,
a computing device operably coupled to the at least one sensor and configured to:
determine a height of the container based on the first distance,
determine a height of the media based on the second distance, and
calculate a fill level of the container based on a ratio of the height of the container and the height of the media.

10. A method for detecting container media fill level, comprising the steps of:
providing at least one sensor comprising an emitter and a receiver,
positioning the at least one sensor in a first position and measuring a height of the container,
positioning the at least one sensor in a second position and measuring a height of media in the container, and
providing a controller in communication with the at least one sensor, the controller calculating a fill level of the container based on a ratio of the height of the container and the height of the media.

11. The method according to claim 10, wherein the step of measuring the height of the container comprises:
emitting an outgoing signal from the at least one sensor towards a surface on which the container rests,
receiving an incoming reflected signal, and
calculating a first distance between the at least one sensor and the surface,
wherein the outgoing signal and the incoming reflected signal do not interact with any portion of the container.

12. The method according to claim 10, wherein the step of measuring the height of media in the container comprises:
emitting an outgoing signal from the at least one sensor towards the media in the container,
receiving an incoming reflected signal, and
calculating a second distance between the sensor and the presence of an amount of media within the container,
wherein the outgoing signal and the incoming reflected signal travel through a container cover.

13. The method according to claim 10, further comprising the step of transmitting the calculated fill level of the container to a user device via a wireless network.

14. The method according to claim 10, further comprising the steps of:
inputting a predetermined threshold fill value,
comparing the calculated fill level of the container to the predetermined threshold fill value,
generate a low salt condition indication if the calculated fill level of the container exceeds the predetermined threshold fill value.

15. The method according to claim 10, wherein the at least one sensor comprises a first sensor and a second sensor, and the method comprises the steps of:
measuring the height of the container with the first sensor, and
measuring the height of media in the container with the second sensor.

16. The method according to claim 10, further comprising the steps of:
storing the measured height of the container value,
repeatedly measuring the height of media in the container,
repeatedly calculating the fill level of the container based on a ratio of the stored height of the container value and the measured height of the media value.

17. The method according to claim 10, wherein the step of positioning the at least one sensor in the first position comprises coupling the at least one sensor to an extension arm and extending the extension arm such that the at least one sensor is positioned adjacent a perimeter of the container.

18. The method according to claim 17, wherein the step of positioning the at least one sensor in the second position comprises collapsing the extension arm such that the at least one sensor is positioned over a container cover.

19. The method according to claim 10, wherein the steps of measuring the height of media in the container and calculating the fill level of the container are performed in predetermined time intervals.

20. The method according to claim 10, wherein the steps of measuring the height of media in the container and calculating the fill level of the container are performed continuously.
